(19) United States
(12) Patent Application Publication
(10) Pub. No.: US 2005/0066764 A1
(43) Pub. Date: Mar. 31, 2005

(54) Adjustable pedal mechanism

(75) Inventors: Andree Burgstaler, Dielingen (DE); Jan Dutz, Damme (DE); Simone Papke, Osnabruck (DE); Wolfgang Meyer, Osnabruck (DE)

Correspondence Address: McGLEW AND TUTTLE;John James McGlew, Scarborough Station, Scarborough, NY, 10510-0827, US

(73) Assignee: ZF Lemforder Metallwaren AG

(21) Appl. No.: 10/953,611

(22) Filed: Sep. 29, 2004

Related U.S. Application Data
(63) Continuation of application No. PCT/DE03/04044, filed on Dec. 9, 2003.

(30) Foreign Application Priority Data
Dec. 9, 2002 (DE) 102 57 631.9
Jun. 20, 2003 (DE) 103 28 103.7

(51) Int. Cl. G05G 1/14

(52) U.S. Cl. 74/512

(57) ABSTRACT

A device is provided for setting a connecting piece (5) mounted pivotably by a mounting device (1), especially a pedal mechanism in a motor vehicle, with which a transmission unit (6) is coupled for transmitting the movement of the connecting piece (5). The setting device has an adjusting mechanism (7) for adjusting the position of the connecting piece (5), a locking unit (8), which prevents the unintended adjustment of the position of the connecting piece (5), and a compensating unit (10) for compensating the change in the distance between the transmission unit (6) and the connecting piece (5), which change is brought about by the adjustment of the position of the connecting piece (5). The mounting device (1) comprises a carriage (3) and is coupled with an adjusting mechanism (7) comprising a drive unit (9), wherein the carriage (3) can be moved linearly via the drive unit (9), and the compensating unit (10) coupled with the carriage (3) and the drive unit (9) compensates essentially the change in the distance between the connecting piece (5) and the transmission unit (6) coupled with the connecting piece (5), which change is linked with the adjustment of the position of the connecting piece (5) arranged on the carriage (3).

### CROSS REFERENCE TO RELATED APPLICATION

This is a continuation of and claims the benefit (35 U.S.C. §120 and 365(c)) of copending International Application PCT/DE 2003/004044 of Dec. 9, 2003, which designated inter alia the United States and which claims the priority of German Application DE 102 57 631.9 of Dec. 9, 2002 and further claims the priority of German Application DE 103 28 103.7. The entire contents of each application is hereby incorporated by reference in its entirety.

### FIELD OF THE INVENTION

The present invention pertains to a device for adjusting a connecting piece mounted pivotably by means of a mounting means, especially a pedal mechanism in a motor vehicle, with which a transmission unit for transmitting the movement of the connecting piece is coupled, comprising an adjusting mechanism for adjusting the position of the connecting piece, a locking unit, which prevents the unintended change in the position of the connecting piece, and a compensating unit for compensating the change in the distance between the connecting piece and the transmission unit, which change is brought about by the adjustment of the position of the connecting piece.

### BACKGROUND OF THE INVENTION

Such devices are usually used in motor vehicles, especially passenger cars, for adjusting control pedals such as brake, clutch and gas pedals. Even though many components, such as the seat, the steering wheel, etc., can already be individually adapted in passenger cars corresponding to the dimensions of the body of the operator, solutions for setting the pedals, one of the most frequently used components of the vehicle, are unusual. However, in order to guarantee the adaptation of the vehicle to the individual and different body dimensions of the different drivers, it is necessary to also make the pedals individually adjustable corresponding to ergonomic expectations and guidelines and thus to guarantee fatigue-free and safe driving. Smaller drivers, in particular, have a seat position that is located close to the steering wheel. The driver is therefore located too close to the air bag in case of a crash. This is to be avoided by a suitable seat position and especially by the individual setting of the pedals.

A device of this class, in which the translatory and rotary adjustment of a connecting piece that is of interest here is performed by means of two separate adjusting mechanisms, is known from DE 100 26 751 A1, wherein separate compensating means essentially compensate the change resulting from the adjustment of the connecting piece in the distance between the transmission unit and the connecting piece.

The drawback that a plurality of components or parts are needed to adjust the connecting piece occurs in the prior-art device. In particular, the mounting of the separate compensating means is complicated, and these means are rather bulky. Furthermore, the adjusting mechanism has a complicated mechanism, whose mounting is also complicated and which is needed for every individual pedal.

A solution in which the connecting pieces are adjusted by rotation by means of a gear mechanism is known from U.S. Pat. No. 5,172,606.

The drawback occurring in this prior-art device is that no separate compensating unit is present and the entire adjusting means must be mounted and set in a complicated manner because of the large number of components.

EP 0 353 958 B1 shows an adjusting mechanism, which makes possible the adjustment of a connecting piece by means of a plurality of arc-shaped guideways.

The drawback that the adjusting mechanism must be mounted and set in a complicated manner because of the large number of components also occurs in this prior-art device. Moreover, the adjusting mechanism must be manufactured in a complicated manner because of the arc-shaped guideways.

The feature common to the aforementioned devices is that the solutions disclosed there have a complicated and expensive mechanism for every individual pedal to be set.

### SUMMARY OF THE INVENTION

The object of the present invention is therefore to provide a device of the above-described type, in which at least one connecting piece can be set with a compact and simple adjusting mechanism, wherein the ratios of the forces remain essentially unaffected by the change in the position of the connecting piece.

According to the invention, a device is provided for setting a connecting piece mounted pivotably by means of a mounting means. The connecting piece is especially a pedal mechanism in a motor vehicle, with which a transmission unit for transmitting the movement of the connecting piece is coupled. The device includes an adjusting mechanism for adjusting the position of the connecting piece, a locking unit, which prevents the unintended adjustment of the position of the connecting piece, and a compensating unit for compensating the change in the distance between the transmission unit and the connecting piece. The change is brought about by the adjustment of the position of the connecting piece. The mounting means comprises a carriage that is coupled with the adjusting mechanism comprising a drive unit. The carriage can be moved linearly via the drive unit, and the compensating unit coupled with the carriage and the drive unit essentially compensates the changes in the distance between the connecting piece and the transmission unit coupled with the connecting piece, which changes are linked with the adjustment of the position of the connecting piece arranged on the carriage.

The present invention includes the technical feature that the mounting means comprises a carriage and is coupled with an adjusting mechanism comprising a drive unit, wherein the carriage is linearly movable by means of the drive unit, and the compensating unit coupled with the carriage and the drive unit essentially compensates the changes in the distance between the connecting piece and the transmission unit coupled with the connecting piece, which changes are linked with the adjustment of the position of the connecting piece arranged on the carriage.

This solution offers the advantage that the adjusting mechanism can be built as a compact unit and no additional space is needed for the installation of separate components due to the integration in the mounting means; the entire device has a modular design, and the safety of the operator is not jeopardized by individual projecting components or parts. A great assembly effort is thus additionally eliminated.

The connecting piece is preferably a pedal of a motor vehicle. However, it is also conceivable that other applications, in which an adjustable pedal mechanism or comparable, adaptable connecting pieces are needed, are equipped with the device according to the present invention.

The operation does not necessarily have to be performed with the foot. It is also conceivable that the device according to the present invention can be used, for example, for positioning a hand lever or the like. Furthermore, it is also conceivable that the device is not related to humans in general. The device may rather also be used in driverless and/or automated systems. The device can thus be used for any kind of machine, device, etc.

It is especially advantageous that the transmission unit transmits a force to a power booster, which correspondingly converts and transmits the force as a manipulated variable for an actuating part, mechanically via a linkage or pneumatically or hydraulically by means of a fluid pressurizing agent. All essential types of transmission means can thus be used with this device.

The transmission unit for the mechanical transmission of a force is preferably designed as an individual push rod. This transmission unit is designed optimally for a brake pedal and offers the operator of the pedal an optimal possibility of metering the force to be set. In addition, the push rod meets the legal requirements concerning safety and requires little space for its installation.

Another measure that improves upon the present invention provides for the transmission unit for transmission by means of a fluid pressurizing agent to be designed as a flexible, mobile line, preferably as a flexible tube, which transmits the force exerted on the connecting piece to a power booster in order to transmit the force as a manipulated variable for an actuating part in a correspondingly converted form. Due to the design as a flexible tube, the transmission unit assumes both the movement transmission function and a compensating function. A separate compensating unit is unnecessary as a result, as a consequence of which the space needed for installation is reduced.

A further improvement is the fact that the transmission unit is coupled with the compensating unit of the adjusting mechanism via a hinge. It is thus ensured that the transmission unit can be correspondingly adapted via the compensating unit to changed requirements such as they develop due to a change in the positions of other components coupled with the compensating unit due to rotation. This type of coupling is possible in a very small space.

Due to the fact that the compensating unit is coupled with the drive unit via a hinge in order to correspondingly transmit a movement generated by the drive unit to the transmission unit to compensate at the same time the distance between the connecting piece and the transmission unit by a rotation in the hinge, an extremely space-saving coupling is possible here as well.

In another advantageous embodiment, the compensating unit is designed as a gear mechanism in order to transmit the change in position generated by the drive unit to the transmission unit in a correspondingly converted manner. The use of a gear mechanism makes it possible to use different transmission possibilities which can be specifically coordinated with the transmission unit.

An advantage is achieved in the same manner by the compensating unit designed as a gear mechanism having essentially a linkage with a plurality of members, which are connected with one another via hinges. This design of the gear mechanism makes possible a possibility for embodying a gear mechanism which can be manufactured in a simple manner and is compact. Different transmission ratios can be set due to the different geometric designs of the individual members in a simple manner.

According to an advantageous variant, the drive unit is connected with the carriage via spindle elements, comprising at least one spindle and at least one spindle nut in order to move the guided carriage linearly. A drive, which can be easily accommodated within the space limited by the mounting means in a very small space, can be obtained by means of a spindle element.

The spindle preferably has two different threads in the area of the spindle nuts, the threads differing mainly by the thread pitch. The thread pitch is selected now to be such that a change in the distance between the connecting piece and the transmission unit is optimally compensated. An optimal compensation is obtained, among other things, by the force ratios between the connecting piece, the transmission unit and the compensating unit remaining essentially unchanged.

Another advantageous variant is obtained by the locking unit being integrated in the drive unit by a self-locking device of the spindle elements. No additional component, which assumes the function of the locking unit, is thus necessary, as a result of which the space needed for installation and the assembly effort are reduced.

The drive unit can be preferably actuated manually and/or electrically by means of a power booster with a corresponding setting means.

The drive unit is preferably connected stationarily with the base plate. The base plate thus represents a mount for the drive unit in connection with the firewall of the vehicle.

It is proposed according to a possible variant of the present invention that the mounting means have as spatial closing elements a front plate and a base plate, between which all components of the device are essentially arranged, wherein the base plate is stationarily connected with the firewall of the vehicle. The entire device can thus easily be mounted, handled and stored as a preassembled module with the two plates as the closing elements.

It is advantageous for the base plate to be stationarily connected with the guides for guiding the carriage.

According to a possible variant of the present invention, the carriage is provided with a first toothed rack, which is in functional connection via a gear with a second toothed rack being held stationarily in relation to the base plate. The axis of the gear is preferably aligned coaxially with the hinge of the coupling between the transmission unit and the compensating unit of the adjusting mechanism. The hinge now follows the movement of the carriage with the connecting piece articulated thereto. The change in the distance between the connecting piece and the transmission unit is thus taken into account.

Other measures improving the present invention are described in the subclaims and will be described in greater detail below together with the description of a preferred exemplary embodiment of the present invention on the basis of the figures.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a front view of a device for setting a mounting means;

FIG. 2 is a sectional view A-A of a device for setting a mounting means according to FIG. 1;

FIG. 3 is an isometric view of a device for setting a mounting means;

FIG. 4 is a side view of possible pedal positions in the frontmost adjusted position in the direction of the vehicle;

FIG. 5 is a side view of possible pedal positions in the rearmost adjusted position in the direction of the vehicle; and

FIG. 6 is a design according to the present invention of an adjustable pedal mechanism with a modified compensating unit compared with FIG. 1.

### DESCRIPTION OF THE PREFERRED EMBODIMENTS

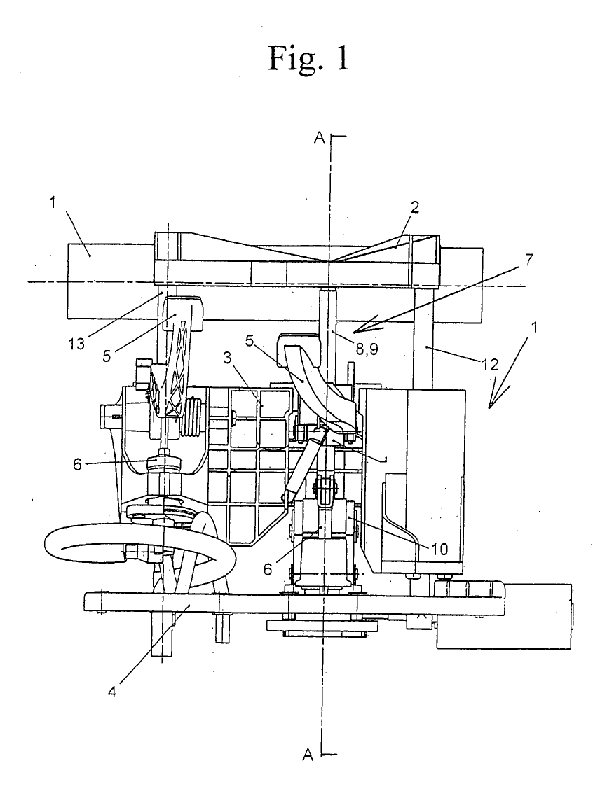

The device for setting a mounting means according to FIG. 1 comprises a mounting means or mounting device 1. The mounting means 1 comprising a front plate 2 closing the mounting means 1 upward over the height, a base plate 4 closing the mounting means 1 downward over the height, and a carriage 3 displaceable linearly between the front plate 2 and the base plate 4, two connecting pieces 5, which are connected with a corresponding transmission unit 6 each, and an adjusting mechanism 7, comprising a locking unit 8, a drive unit 9 and a compensating unit 10.

The mounting means 1 is stationarily connected with a cross rail 11 of the vehicle by means of the front plate 2 on the upper side, as a result of which the mounting means 1 is mounted at one point.

Two guides 12, 13, which are located at spaced locations from one another and are directed perpendicularly to the plane of the plate, are fastened to the front plate 2 on the head side thereof. The carriage 3, surrounding the two guides 12, 13 in correspondingly designed mounts, is linearly movable on the guides 12, 13. The guides 12, 13 are likewise directed perpendicularly to the plane of the plate at their foot side with the base plate 4, wherein the guide 12 may be designed as a square bar and the guide 13 as a round bar. The base plate 4 in turn is stationarily connected with the firewall of the vehicle (not shown here) and thus represents the second mounting point of the mounting means 1.

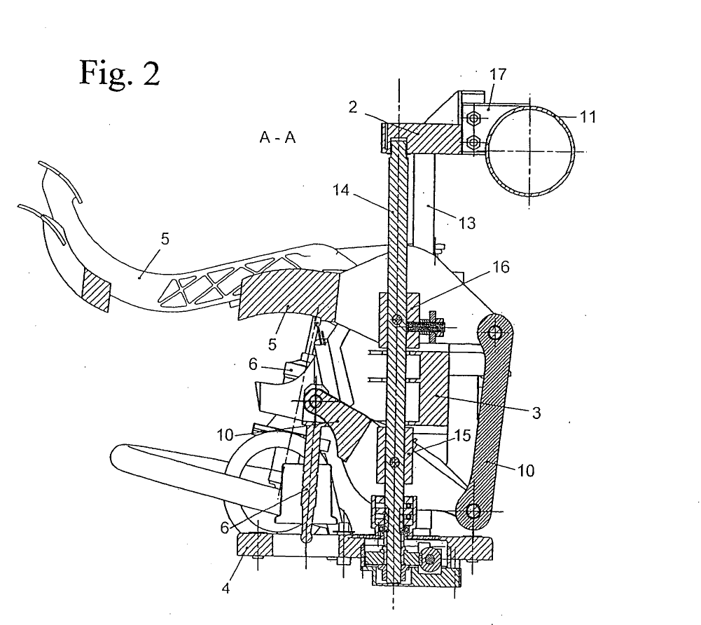

Moreover, the drive unit 9 is stationarily connected with the base plate 4. This drive unit 9 comprises an electric motor, a gear mechanism, a spindle 14 and two spindle nuts 15, 16, as this is apparent from FIG. 2. The spindle 14 is set into rotation via an electric motor and the gear mechanism following same, as a result of which both spindle nuts 15, 16 move in the longitudinal direction of the spindle.

The carriage 3 is stationarily fastened to the spindle nut 16. The carriage 3 is moved linearly by the movement of the spindle nut 16 along the guides 12, 13 in relation to the base plate 4 and the front plate 2. The guide 12 on the side of the E-gas module, which controls the electronic gas pedal transmission, guides the carriage 3 in the axial direction only in order to avoid a redundancy of the system and consequently the jamming of the carriage 3. Among other things, the two connecting pieces 5 and the compensating units 10 are stationarily connected with the carriage 3. The connecting pieces 5 move as well correspondingly during the linear movement of the carriage 3. The consequence of this is that the distance between the connecting piece 5 and the transmission unit 6 does not correspond to the original value any longer.

According to FIG. 2, the cross rail 11 of the vehicle is of a tubular design. The front plate 2 is connected with the cross rail 111 of the vehicle via a bracket 17, which is detachably connected with the front plate 2, wherein the bracket 17 is adaptable to the outer contour of the cross rail 11 of the vehicle in order to establish an optimal connection. The spindle 14 is mounted on one side in the front plate 2 via a spindle pin. On the other side, the spindle 14 is led through the base plate 4. A drive unit 9, which is preferably designed as an electric motor with an integrated gear mechanism, and which drives the spindle 14, is arranged under the base plate 4. The spindle nuts 15, 16 located between the front plate 2 and the base plate 4 convert the rotary movement of the spindle into a translatory movement, as a result of which the carriage 3 connected with the second spindle nut 16 and the compensating unit 10, which is connected with the first spindle nut 15 and is designed as a linkage, are adjustable. The compensating unit 10 designed as a linkage is designed as a kinematic chain or generally as a gear mechanism. The first linkage part is connected here with the carriage 3 via a hinge. The second linkage part is in turn connected with the first linkage part via a hinge. Moreover, approximately in the area of its center of gravity, the second linkage part is connected rotatably with the first spindle nut 15, with which the linkage follows the movement of the carriage 3. The other end of the second linkage part is connected rotatably with the transmission unit 6 designed as a push rod. Thus, the change in the relative position of the connecting piece 5 in relation to the push rod is thus compensated during a change in the position of the connecting piece 5 designed as a brake pedal by the compensating unit 10 designed as a compensating linkage comprising a connecting rod and a reversing lever such that the second spindle nut 16 and consequently also the other connection point of the reversing lever will move twice as fast as the first spindle nut 15, as a result of which the connection point between the push rod and the reversing lever remains approximately in its position.

A connecting piece 5 designed as a clutch pedal can also be seen beside a connecting piece 5 designed as a brake pedal. The transmission unit 6, which is coupled with the clutch pedal and which is designed in the form of a clutch master cylinder, is coupled with a compensating unit 10, designed as a flexible tube here. The necessary position compensation resulting from the change in the position of the carriage 3 takes place here as a simple following of the flexible tube.

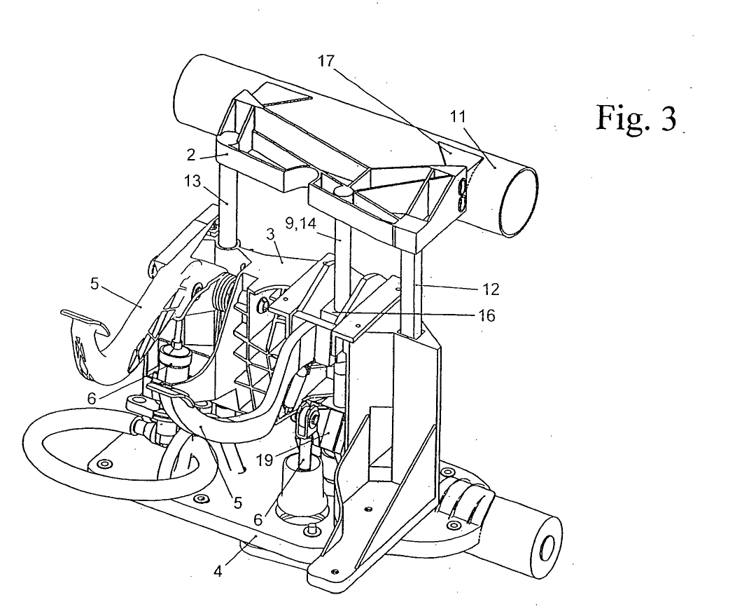

The carriage 3 according to FIG. 3 is preferably manufactured from a plastic in order to reduce the weight. Corresponding ribs are provided to increase the strength and the rigidity. Two connecting pieces 5 are accommodated on the mounting means 1 shown here, one connecting piece 5 being designed as a brake pedal and the other as a clutch pedal. However, additional connecting pieces, e.g., a gas pedal, may also be accommodated on the mounting means 1.

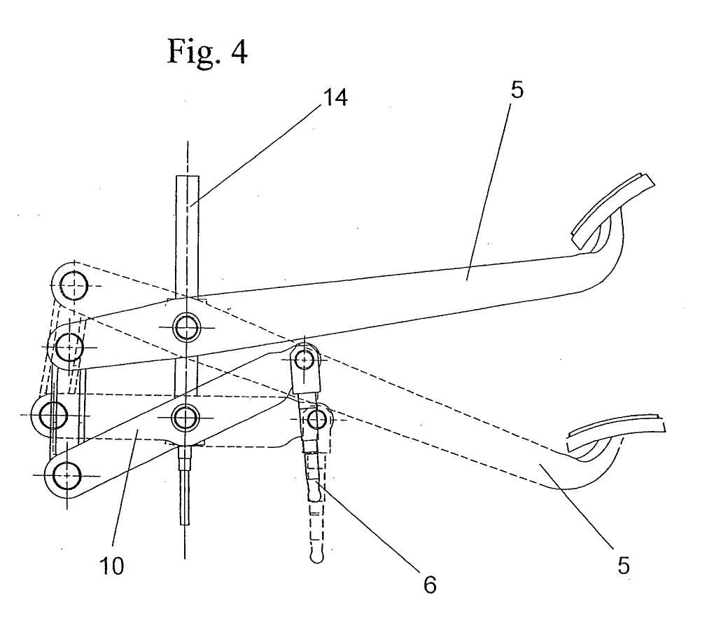

FIG. 4 shows a connecting piece 5 designed as a pedal and an adjusting mechanism according to the present invention in different positions. The adjusting mechanism comprises here a transmission unit 6, a compensating unit 10 and a spindle 14 with two spindle nuts. The pedal is set here such that the position of the pedal is suitable for a very large person, i.e., the pedal is arranged in the position located farthest away from the person. Two positions of the pedal are shown in FIG. 4: The first position shows the pedal in the unactuated position, and the second position shows the pedal in the actuated position. The unactuated position of the pedal is indicated by solid lines, and the actuated position of the pedal is indicated by broken lines. If the pedal is actuated, this movement is transmitted via the fulcrum point of the pedal on the compensating unit 10 to the transmission unit 6. The transmission unit 6 is now moved in the same direction as the pedal. The transmission takes place mechanically via different levers or lever lengths. Based on two different threads in the area of the two spindle nuts, the spindle nuts move differently in relation to one another. As a result, the distance between the two spindle nuts also changes during the simultaneous adjustment of the pedal. The variable distance makes it possible to maintain a nearly constant position of the connection point between the transmission unit and the overall system.

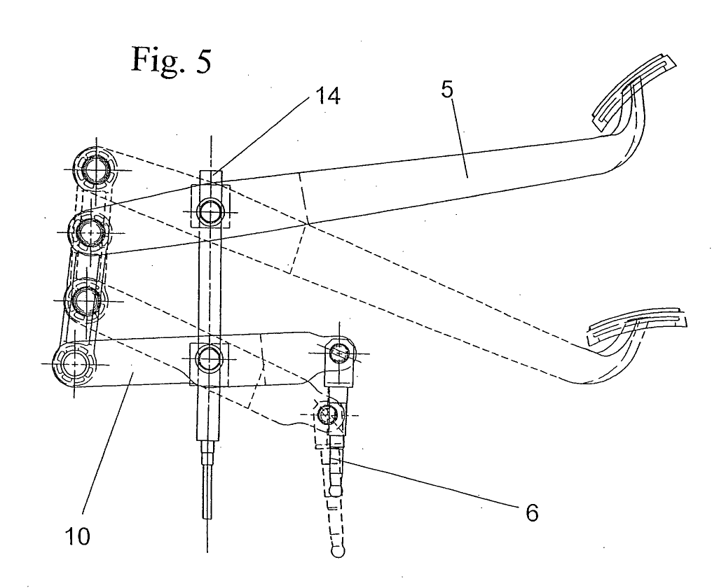

FIG. 5 likewise shows a connecting piece 5 designed as a pedal and an adjusting mechanism according to the present invention in different positions. The adjusting mechanism comprises here a transmission unit 6, a compensating unit 10 and a spindle 14 with two spindle nuts. The pedal is set here such that the position of the pedal is suitable for a very small person, i.e., the pedal is arranged at the least far position from the person. What was stated above in connection with FIG. 4 also applies to the positions of the pedal in the actuated and unactuated positions as well as to the change in the movement of the pedal between these positions. The different distances of the spindle nuts, at which the pedal or the compensating unit 10 is mounted, are recognized at equal pedal deflection compared with FIG. 4. The distance between the spindle nuts in FIG. 5 is about twice that in FIG. 4. Despite the change in the pedal position by the compensating unit 10, the effects are not practically noticeable to the operator due to the adjusting mechanism according to the present invention.

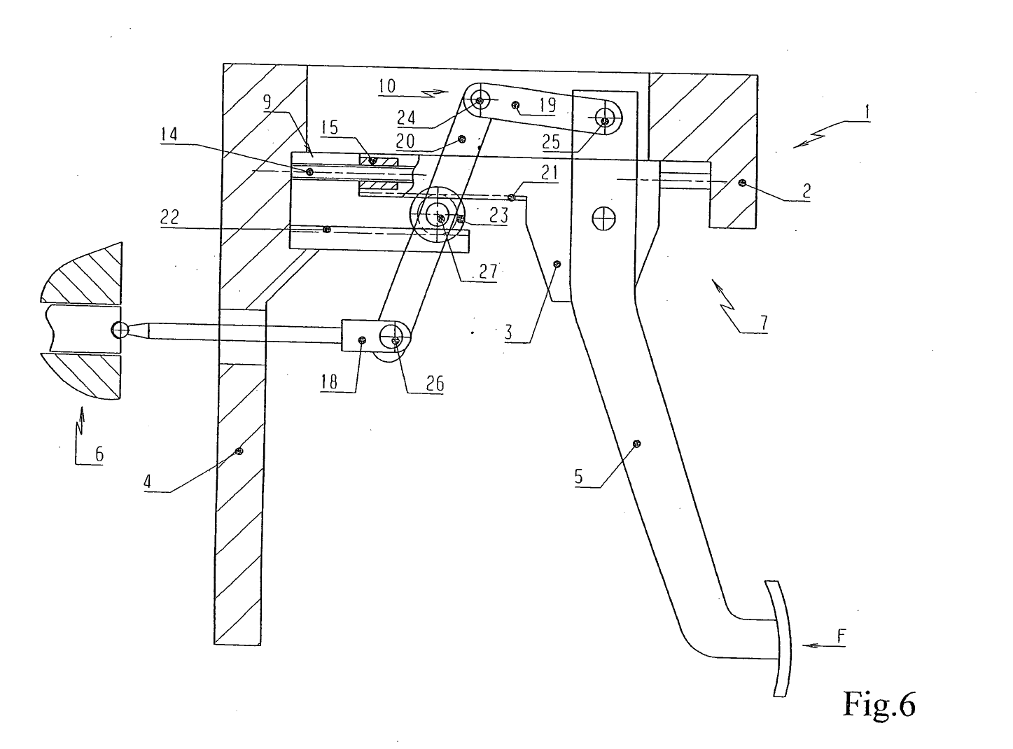

The adjustable pedal mechanism shown in FIG. 6 has a compensating unit 10, which differs from that in FIG. 1 and is coupled with the transmission unit 6 via a push rod 18.

The movement of the carriage 3 takes place analogously to FIG. 1 and does not therefore need to be repeated here. Among other things, the at least one connecting piece 5, which is designed as a brake pedal of a motor vehicle, and the compensating unit 10, which is formed essentially by a coupling lever 19 as well as a reversing lever 20, are stationarily and rotatably connected with the carriage 3. The connecting piece 5 moves along correspondingly during the linear movement of the carriage 3. The consequence of this is that the distance between the connecting piece 5 and the transmission unit 6 does not correspond to the original value any longer.

Furthermore, a first toothed rack 21 is connected with the carriage 3. Corresponding to this, a second toothed rack 22 is fastened stationarily to the base plate 4. Furthermore, a gear 23, which establishes a functional connection between the two toothed racks 21, 22, is arranged between the two toothed racks 21, 22.

The coupling rod 19 and the reversing lever 20 are mounted pivotably in relation to one another in a fulcrum point 24. Furthermore, the compensating unit 10 is articulated at one end to the connecting piece 5 via the fulcrum point 25 and is connected at the other end with a push rod 18 acting on the transmission unit via another fulcrum point 26 in an articulated manner. The reversing lever 20 is pivotably connected with the gear 23 via a hinge 27 in the middle between the two fulcrum points 24 and 26. The axis of the gear 23 and the axis of the hinge 27 are aligned coaxially with one another.

If the carriage 3 is displaced with the connecting piece 5 connected thereto, this movement is transmitted to the gear 23 via the toothed racks 21 and 22. The gear 23 is displaced by only half the path of the carriage 3 because of the tooth pairing, so that the reversing lever 20, which is coupled with the gear 23 and, via the coupling lever 19, with the connecting piece 5, pivots around the axis of the hinge 27. The fulcrum point 26 between the push rod 18 and the reversing lever 20 now changes its position only insignificantly, so that the change in the distance between the connecting piece 5 and the transmission unit 6 which is associated with the adjustment of the connecting piece 5 is compensated with the compensating unit 10. The angular position of the connecting piece 5 remains unchanged during the entire adjustment process. The transmission ratio is affected only slightly with the adjustment of the connecting piece, because the effective lever lengths do not change substantially.

In order for the connecting pieces to be able to be lowered in the direction of the operator for easier operation, provisions may, furthermore, be made for the mounting means as a whole to be inserted in a sloped position in the body in relation to the bottom of the vehicle, so that the connecting pieces come closer to the bottom of the vehicle during the adjustment of the connecting pieces in the direction of the operator. It is thus guaranteed that smaller operators with generally smaller feet are also able to optimally reach the connecting pieces, which are designed as pedals here. In case of such an arrangement of the mounting means, the spindle 14 is arranged, in particular, in a downwardly directed direction in the direction of the operator, and the other components are arranged such that they are adapted thereto for the safety of the function of the adjusting device.

If a force F is applied to the connecting piece 5 in order to actuate the brake device connected to the transmission unit 6, the connecting piece is pivoted in relation to the carriage and the linkage of the compensating unit 10, the coupling lever 19 and the reversing lever 20 are deflected. The reversing lever 20 now pivots around its axis aligned coaxially with the axis of the gear 23 and transmits its pressing force, which acts on the transmission unit, to the push rod 18. The reversing lever 20 is supported now via the gear 23 against the toothed racks 21 and 22.

If a plurality of connecting pieces 5 in the form of pedals or similar devices are mounted on the carriage 3, all connecting pieces 5 can be advantageously displaced simultaneously. The compensating unit according to the present invention, which is shown here, as well as any other prior-art means may be used to compensate the changes in the distance between the particular connecting piece and the corresponding transmission unit. Since the adjusting mechanism is integrated in the mounting means 1, a favorable modular design is, furthermore, facilitated. If the connecting pieces 5 and optionally other components are made of a plastic, the advantage of a weight reduction is, furthermore, achieved compared with conventional pedal mechanisms, and it becomes possible to reuse commonly used components from fixed pedal mechanisms, for example, E-gas modules.

Concerning future technologies, for example, brake-by-wire (similar to the E-gas module), it is also possible to use exclusively electronic pedals with the present invention without any great effort without a force transmission being necessary.

While specific embodiments of the invention have been shown and described in detail to illustrate the application of the principles of the invention, it will be understood that the invention may be embodied otherwise without departing from such principles.

1. A setting device for setting a connecting piece mounted pivotably and with a transmission unit coupled to the connecting piece for transmitting the movement of the connecting piece, the setting device comprising:
a mounting device for pivotably mounting the connecting piece;
an adjusting mechanism for adjusting the position of the connecting piece;
a locking unit to prevent an unintended adjustment of the position of the connecting piece;
a compensating unit for compensating a change in the distance between the transmission unit and the connecting piece, which change is brought about by the adjustment of the position of the connecting piece, said mounting device including a carriage coupled with said adjusting mechanism, said adjusting mechanism comprising a drive unit, wherein the carriage can be moved linearly via said drive unit, and said compensating unit is coupled with said carriage and said drive unit essentially compensates the changes in the distance between the connecting piece and the transmission unit coupled with the connecting piece, which changes are linked with the adjustment of the position of the connecting piece arranged on said carriage.

2. A device in accordance with claim 1, wherein the connecting piece is a pedal of a motor vehicle.

3. A device in accordance with claim 1, wherein the transmission unit transmits a force to a power booster, which converts and transmits the force as a manipulated variable for an actuating part mechanically via a linkage or pneumatically or hydraulically by means of a fluid pressurizing agent.

4. A device in accordance with claim 1, wherein for transmission by means of a fluid pressurizing agent, the transmission unit is designed as a flexible, mobile line including a flexible tube, which transmits the force exerted on the connecting piece to a power booster in order to transmit the force as a manipulated variable for an actuating part in a correspondingly converted form.

5. A device in accordance with claim 1, wherein the transmission unit is coupled with the compensating unit of the adjusting mechanism via a hinge.

6. A device in accordance with claim 5, wherein said compensating unit is coupled with said drive unit via a hinge in order to correspondingly transmit a movement generated by said drive unit to the transmission unit and to compensate at the same time a distance between the connecting piece and the transmission unit via a rotation in said hinge.

7. A device in accordance with claim 1, wherein the compensating unit includes a gear mechanism in order to transmit the change in position generated by said drive unit to said transmission unit in a correspondingly converted form.

8. A device in accordance with claim 7, wherein said compensating unit designed as a gear mechanism has essentially a linkage with a plurality of members, which are connected with one another via hinges.

9. A device in accordance with claim 1, wherein said drive unit is connected with said carriage via spindle elements comprising at least one said spindle and at least one spindle nut in order to move the guided carriage linearly.

10. A device in accordance with claim 9, wherein said spindle has two different threads in the area of the spindle nuts, wherein the threads differ mainly in the thread pitch.

11. A device in accordance with claim 9, wherein the locking unit is integrated in said drive unit via a self-locking device of said spindle elements.

12. A device in accordance with claim 1, wherein said drive unit can be driven manually or electrically via a power booster with an associated adjusting means.

13. A device in accordance with claim 1, wherein said drive unit is stationarily connected with a base plate.

14. A device in accordance with claim 1, wherein said mounting device has as spatial closing elements comprised of a front plate and a base plate, between which essentially all components of the setting device are arranged, said base plate being stationarily connected with a firewall of the vehicle.

15. A device in accordance with claim 14, wherein said base plate is stationarily connected with guides for guiding said carriage.

16. A device in accordance with claim 5, wherein said hinge of said compensating unit is in functional connection with a gear, which is located between two toothed racks which are arranged displaceably in relation to one another.

17. A device in accordance with claim 5, wherein said hinge is arranged in the middle between two outer articulation points of a reversing lever of said compensating unit.

18. A device in accordance with claim 16, wherein an axis of a gear and an axis of said hinge connected with said compensating unit are arranged coaxially with one another.

19. A device in accordance with claim 16, wherein a first toothed rack is arranged displaceably with said carriage.

20. A device in accordance with claim 16, wherein the connecting piece comprises a pedal mechanism and/or a body and a second toothed rack is held stationarily in relation to a base plate of the pedal mechanism and/or the body.
